(19) United States
(12) Patent Application Publication
(10) Pub. No.: US 2006/0026065 A1
(43) Pub. Date: Feb. 2, 2006

(54) Digital entertainment distribution system

(76) Inventors: Hugo Andres Bolatti, Vicente Lopez (AR); Eduardo Bondio, Vicente Lopez (AR)

Correspondence Address: SHOEMAKER AND MATTARE, LTD, 10 POST OFFICE ROAD - SUITE 110, SILVER SPRING, MD, 20910, US

(21) Appl. No.: 11/111,997

(22) Filed: Apr. 22, 2005

Related U.S. Application Data
(60) Provisional application No. 60/564,222, filed on Apr. 22, 2004.

(51) Int. Cl. G06Q 30/00

(52) U.S. Cl. 705/14

(57) ABSTRACT

Customers can browse, preview, select and purchase digital entertainment products, such as music or movies, at kiosks or point-of-sale locations connected to a central source of digital entertainment content. The products can be paid for or their price subsidized by credits which the customers have obtained from non-competing companies as part of those companies' own marketing efforts.

This application claims benefit of the Apr. 22, 2004 filing date of provisional application 60/564,222.

### FIELD OF THE INVENTION

This invention is in the field of consumer product goods distribution and sales systems, and is particularly directed to a system for distributing and marketing electronic information content such as music to customers.

### BACKGROUND

There are many systems currently in use through which one may listen to or purchase music and other digital content in CD-like media, or download such content. In systems having conventional brick and mortar distribution channels (stores that distribute physical merchandise), a prerequisite is that the customer must have previously decided to approach the entertainment offer. Mainstream access to this offer is mostly limited to specific stores, like music or video stores or specific departments of larger stores. The offer is not personalized and cannot be customized because it is prepackaged.

With most such systems, the product search mechanism is restricted to a few variables and normally requires staff assistance. Inventory is typically limited to circumstantial stock, and sample availability is limited. To assure availability, it may be necessary to purchase products at selection time. The customer may be able to view only previews (not the full product) before buying, and the sample system may be slow or inconvenient. In these systems, there are limited carrier and format options. The product price is perceived to be high, as it has to include all of the content and the seller's costs and margins. Another problem with prior systems is that other content related to a selected item is generally not readily available and accessible with the main product. Product promotion is limited to the product owners' initiatives or the sellers' initiatives and customers face heterogeneous purchase experiences.

In prior systems having World Wide Web distribution channels, it is also a prerequisite that the customer must have previously decided to approach the entertainment offer.

In such other systems, access to desired content is not simple for the average consumer, sampling is dependent on internet connection speed and product carriers and formats available to customers are limited to customers' hardware and software setup. Payment options are also limited. Also, as in prior brick and mortar systems, web based distribution channels' product promotion is limited to the product owners' or the sellers' initiatives.

### SUMMARY OF THE INVENTION

This invention provides a new sales and distribution channel for entertainment products and services, which overcomes the identified shortcomings of prior content distribution and sales systems.

A purpose of the invention is to provide consumers more dedicated access points and longer in-person access hours, wider content base and range, greater ease of use, a simple homogeneous and appealing interface, a variety of carriers and formats, personalized and fully customizable products, a structurally sustained lower pricing capability, and multiple payment alternatives. Another object of the invention is to achieve increased sales and a legal auditable distribution mechanism for entertainment content product and service providers.

Other objects are to reduce inventory requirements, logistics and marketing costs.

The invention provides several advantages over prior systems. For example, whereas previous systems require that a customer first decide to approach the entertainment offer, this invention does not require previous decision since it continually offers entertainment products through dedicated highly visible points of access, such as touchscreen terminals and kiosks, in locations target customers visit most frequently in ordinary activities not directly related to entertainment. To maximize such incidental contact, the invention makes entertainment content widely available through a vast network of heterogeneous third party locations (e.g., school and college recreational areas, bars, fast food restaurants, coffee stores, shopping mall walkways, etc.) throughout its area of coverage.

In contrast to prepackaged systems, this invention allows customers to obtain standard or personalized and fully customized products to the extent permitted by the products themselves. By choosing a combination of image, sound and data products that the invention makes available, customers are able to build their own selection of items. For example, in the case of music products, a customer can select specific title selections, with or without related content such as video clips, karaoke, tabs, lyrics, artist bios, etc., in specific play order, and then choose a medium such as CD (or any other available physical carrier like a DVD) with personalized cover art and customer selected formats. Alternatively, he can decide simply to download the content onto a digital device like a personal digital player or recorder, a cell phone, or any other digital device supported by the invention, in a customer selected format. Mixed products can also be made available, i.e., music titles, plus video games, plus sports events images, all in one carrier.

This invention limits the need for staff assistance, in that it allows multiple search variables based on the information on its on-line content database, and in that it has a simple human-oriented inviting touch screen and/or voice command interface supported by context sensitive or customer requested tutorials and an option to access online help, live, from specialists.

Inasmuch as the invention includes a digital database and distribution arrangement composed of one or many related databases, it is not limited by physical stocks. Consequently, product samples of all products carried are readily available and may be instantaneously accessed.

This invention provides greater format flexibility, allowing the selection of at least CDs and PDA-type devices, and at least the following formats: MP-3, WAV, MPEG, MOV, DVₓ, JPG, GIF, BMP, PDF, EXE.

Another attractive feature of this invention is that it makes available to the customer a wide range of related product offerings, e.g., music titles, karaoke versions, tabs, lyrics etc.

The invention, rather than forcing on-the-spot product purchase, maintains digital content in its database so that content selections may be placed in wish lists to be edited and/or purchased in future customer access opportunities.

In contrast to internet solutions, this invention allows customers at all the inventive system's locations to obtain products purchased from the system quickly and in physical carriers that are produced on the spot under industry quality standards, besides providing the ability to make downloads.

A particularly important feature of this invention is that it provides customers with a structural, consistent and sustainable mechanism to reduce product prices and make them flexible. In practice, not only can customers buy entertainment credits, using any of the payment methods available in an average store; they can also obtain Entertainment Credits regularly from system sponsors without paying a price. Consequently, when system customers use a portion of the credits they have earned to pay for entertainment content, they normally pay less for these products and in some circumstances they can even get the products virtually free. This increases the customers' fidelity toward the channel, discouraging illegal purchase or file sharing practices. It is also important to point out that this mechanism benefits content owners in that their royalties or prices are paid by the system on content sold as if customers had paid the full price and in that customers rehabilitated from illegal practices translate into more sales for them too.

As the invention provides a distinct single brand channel based on a unique customer interface, computer application and infrastructure and consequently, functionality and policies are homogeneous throughout the system.

As with prior systems, content owner initiatives and the channel's own initiatives may lead to content purchase; however, in addition, the system has the continued promotional support of a sponsor network, an agent network, and an associated media network.

### BRIEF DESCRIPTION OF THE DRAWING

The accompanying drawing is a diagrammatic illustration of a system embodying the invention.

### DESCRIPTION OF THE PREFERRED EMBODIMENTS

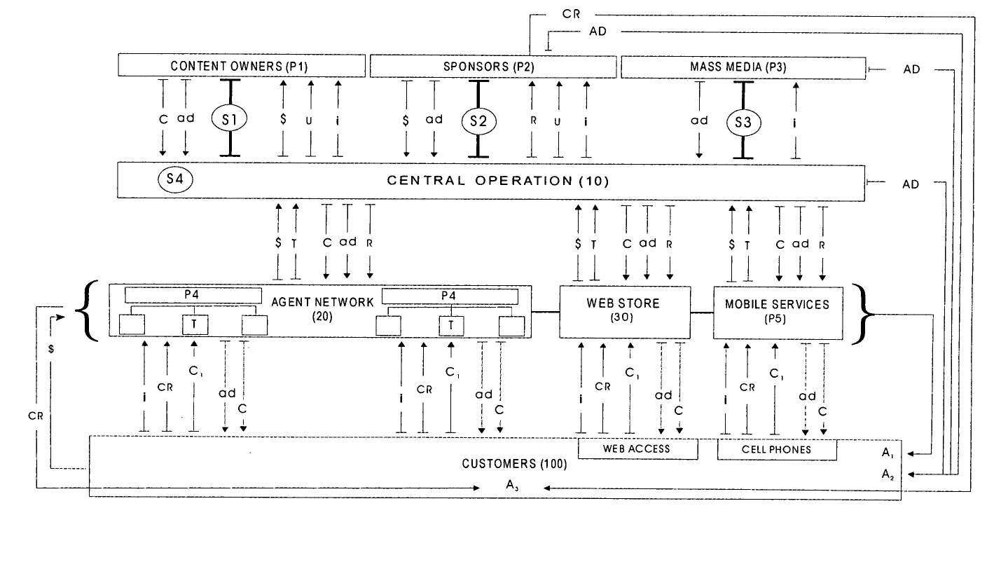

As shown in FIG. 1, a system embodying the invention comprises four major components: content owners P1, sponsors P2, mass media P3 and a network 20 of agents P4 whose interactions with customers 100 are facilitated by a central operation 10. The central operation is “central” in the virtual sense, even though it may be distributed between plural physical locations. The circles S1, S2 and S3 denote infrastructure (e.g., communications links, software and access tools) through which the central operation communicates with the content owners, sponsors and mass media, respectively.

The central operation 10 downloads digital entertainment content “C” into its databases S4 from the content owners P1 (i.e. music labels, producers, movie studios, game manufacturers, etc.), in order to make it available to the customers 100. In return, the content owners receive royalties “$”, auditing information “I” and customer track record information “i”. The central operation 10 also accepts advertizing material (ad) from content owners P1, sponsors P2 and mass media P3 that it will publish for them on the system.

Concurrently, the system induces the sponsors P2 (mass product and service marketers) to invest a portion of their marketing budgets or their general budgets to buy entertainment credit issuing rights “R” from the system. The sponsors may then distribute Entertainment Credits “CR” with their products or through other channels such as direct mailing to their own customers. In this manner, Entertainment Credits reach consumers en masse. To make consumers aware of this benefit, Sponsors may promote in their advertising campaigns AD the fact that their products carry Entertainment Credits that can be applied towards payment for entertainment products offered by the system through the entertainment agent network 20 or the web store 30 and/or the customer's cellular phone and/or other channels that may be added in the future.

The system distributes entertainment offers to potential customers through the Agent Network 30. The Agent Network is composed of strategically chosen and distributed locations which potential target customers habitually visit (i.e. bars, fast foods, malls, meeting points, cafeterias, etc.). At these locations, in order to assure many customer “hit points”, there are inviting touch screen customer terminals (or kiosks) T. The terminals enable potential customers to interact with the entertainment offer and to apply entertainment credits received from Sponsors towards the price of the entertainment content from Content Owners available at the terminals. These potential customers, attracted by continuous air play, messages and other marketing techniques, can, among other activities:
(a) browse, preview and select desired content;
(b) play a full music title, play a video game, etc.;
(c) store wish lists;
(d) customize and personalize presentation and packaging of products selected;
(e) redeem Entertainment Credits issued and distributed by the sponsors, to be applied to the purchase of any of the products included in the entertainment offer;
(f) purchase any of the products of the entertainment offer by paying the full price for them or the balance after Entertainment Credit redemptions, using any of the existing payment methods available;
(g) download content into a physical medium such as a PDA or a CD;
(h) send selected content to other persons; and
(I) upload content.

In addition to the above, the system provides Internet access to its web store 30, through which customers can interact with the system using the same functionality as described for the Agent Network, only limited by the circumstances of the customer's access point set up and media support.

A business system representing a preferred embodiment of the invention includes two major components: a contract framework and a technology solution.

The contract framework preferably is a set of four types of contracts: content owner contracts, sponsor contracts, agent contracts and media company contracts.

The content owner contracts preferably require the Content Owners to provide digital content “C” for sale in any form and promotional material, and the invention provides, in return, security for the digital content, a distribution and sales network, incentives for customers as to increase content sales, payment for content sold in any form as required, advertising, auditing information, statistics, web access and a call center.

The sponsor contracts preferably obligate Sponsors to purchase credit issuing rights “R” authorizing them to issue and distribute entertainment credits with their products (i.e. as a numbered code, bar code, or other method as sponsor products allow) and to advertise the system in their own product advertisement campaigns. The system in return provides the system's sales channels to accept sponsor Entertainment Credits, Sponsor advertising on the system's network, auditing information, statistics (i.e. information on Sponsor credit redemption by product, area, date, etc.), web access and call center.

Under the preferred agent contracts, Agents provide agent site infrastructure (space, energy, sporadic staff attention to setup, etc), agent sales staffs dedication as needed, the sale of Entertainment Credits to those customers that need them to buy entertainment products, a credit card or credit worthy account with a direct ACH feature or other method so that the system can collect Entertainment Credit sales for the entertainment credits sold by agent and promotion of the entertainment offering. The system provides agent technology infrastructure, promotion of agent locations, margin for agent markup on Entertainment Credits agent sales, statistics (i.e. sales by date, hours, credit redemptions, etc.), web access and a call center.

The preferred company contracts obligate mass media companies P3 to provide their air play lists and space for advertising on their air time. In return, the system administration provides space for media company advertizing AD in the form of show banners or other means and various statistics “i”. Reference S3 indicates the infrastructure through which the media companies and the central operation communicate.

The technology solution (hardware, software and communications on which the invention is implemented) preferably includes a central server for storing content and for system administration, administration of the web site and other channels and operational purposes, distributed agent servers 42 containing selected desired local and/or regional content needed at agent locations based on marketing and system information and system administration for operation purposes; and also at those agent locations, distributed agent terminals or kiosks having an interface for customer interaction. The technology solution also includes communication links among servers and between servers and terminals and provides the operational and maintenance tasks required by the complete system structure. In other preferred embodiments and modes of operation, this technology solution may vary substantially. For example, it may be set up with a centralized architecture, composed of a central server and a distributed network of agent terminals or kiosks with their customer interface for customer interaction, plus the communications, operations and maintenance setups required by this architecture.

The sponsors P2 interact with their customers 100 by (a) distributing free Entertainment Credits “CR” to the public with their products or by other means like distribution at events, mailings, etc., in various formats, depending on the method of distribution and (b) publicizing and promoting their Entertainment Credit distribution activity and its benefits in their general or specific advertisement campaigns. The Sponsors buy Entertainment Credits from the system and then distribute them free to their customers by, for example, reassigning a portion of their marketing budget to their customers, in the form of Entertainment Credits, so that the customers can regularly use those Entertainment Credits to purchase music or other entertainment content. System customers thus pay less for products sold by the entertainment channel, thanks to the credits issued and distributed free to them by the sponsors. Customers may even get the products free, by paying for them entirely with sponsor-distributed Entertainment Credits.

The Sponsors agree with the system administration to contract terms like Entertainment Credit issuance volumes, Entertainment Credit values, estimated redemption volumes, maximum expenditures, Entertainment Credit valid through dates, region specific matters and Entertainment Credit customer utilization parameters, among other matters. Payments of Entertainment Credits by Sponsors to the system, may or may not be tied totally or partially to entertainment sales, Sponsor customer Entertainment Credit uploads or effective Entertainment Credit redemptions. Sponsors can receive Entertainment Credit issuance rights in the form of passwords, password generation tools or through other methods, for distribution to their customers. The sponsors have secure access to the system so that they can obtain qualitative and quantitative information about system Agents, customers and Entertainment Credit redemption data, plus information on their customers' behaviors, including redemption rates, types of content accessed, places and hours of their system usage, frequency of use, cash spent to complete accumulated Entertainment Credits redeemed by customers when purchasing system products and services, and so on. In addition, the Sponsors can purchase advertising for the Entertainment Terminal advertisement spots.

In use, a potential customer, having received or purchased redeemable Entertainment Credits, may access the system's web site, enters the required identification data and uploads his Entertainment Credits into an account maintained by the system administration. He may then listen to and/or view sample content, build a selection using a similar graphic interface as the one he used at the Terminals in the Agent Network and/or purchase the selection by redeeming the Entertainment Credits he has uploaded into his account among other interactions. Upon making a purchase, the customer may specify a method of delivery, enjoy the full play of the selections or download them in the available formats.

At common areas of an Agent location, the prospective customer can observe and listen to entertainment air play and to communication schemes from the Agent's audiovisual system (if available) or from the Terminals throughout the location. He may also (a) receive Entertainment Credits with products and services from Sponsors he happens to purchase at the Agent location, (b) buy Entertainment Credits from the Agent with credit card, cash, funds transfer or virtual money and (c) pick up content in carriers such as CDs.

A customer can preview content and interact with the system as described above through the Terminal interface. Depending on system requirements, customers may have to enter personal identification and other data (like birth date, for age dependent content). Customers may contact the system by telephone, e-mail, through the Terminal or by accessing the web site.

Each agent may, from a special Terminal at the agent location or from the system's web site, log into the system to input or maintain payment means, buy Entertainment Credits, pay for them using a secure payment means and load them into his account to resell. The Agent may also check his account status, transfer Entertainment Credits from his account to the account of a registered customer (when he sells Entertainment credits from his account to customers), or load Entertainment Credits purchased from other Agents to a registered customer account. If the agent encounters a product having problems (e.g., recording fault or printing defect), he may input a product code and customer's name and/or id number, and inserts the faulty carrier into a special container in the Agent setup where rerecording and printing is automatically triggered to replace defective product.

The Agent is responsible for administrating the system on his site, performing normal maintenance chores including resetting terminals and the complete system, disabling or reprogramming times for automatic system startup and shut down, redistributing terminals within the site, and accepting access to system by authorized third parties. He may also disable or activate portable terminals, and is responsible for tasks such as battery maintenance.

The Agent can electronically access to terms of his contract with the system and details of required promotional activity. He can propose new activity and can also retrieve information on system maintenance, consumable reposition and promotional material maintenance. He may be entitled to access information on his own commercial activity, including accounts receivable and payable, and can engage in automated clearing house administration. An Agent can also monitor personnel activity, both historical and prospective, at his own location, and can interact with the system through the agent call center, the web site, or by email.

The Content Owners may promote artists and tours through the system, advertise content, and advertise new channels through public media and through the system.

The Content Owners may have access to terms of agreement with the system, upload digital content masters to the system by delivering physical media or through secure electronic transfer mechanisms or other mechanisms, update content with new information (photos, headlines, dates, events, etc.), access real time information on sales of entertainment content by titles, title groups, agents, regions, unit totals, etc. and receive accounting and statistical information. The system may provide these vendors access to automatic calculation of royalties/fees and Entertainment debits as per terms of vendor contract and activity, and may enable vendors to receive credits to their account for content sold by the system in accordance with contract terms and to receive debits to their account for advertising and promotion made through the Entertainment network as per such an agreement.

Vendors of other content such as movies, TV, cable and radio programs or stations can promote the system in their own advertising and can use the system to advertise their air play, shows etc. Such vendors may also access their contract information, calculate royalties to which they are entitled under their contract, upload committed content, and receive statistics of visits to their content, among other activities.

Technology vendors may install, move, maintain, and uninstall equipment and software, in compliance with the system's general layout plan and periodic instructions. These vendors initially train the agents' personnel, particularly the system's trainers, and subsequently provide assistance in response to service requests from agents and the system. The technology vendors automatically generate reports on activity history and follow-up actions, service requests and alarms for preestablished events, system activity and use of consumables.

The technology vendors are responsible for hosting, operation and maintenance of the complete system as necessary to maintain service (central and distributed). They establish automatic alarm settings for consumable requests, system warnings, failures, faults and automatic communication to vendors. They record all events (service requests and services executed until slip closed) and follow up until each problem is solved.

A technology vendor may also function as a consumable vendor. Thus, he may maintain an activity log at the agent locations, periodically delivery consumables, and make unscheduled service call responses. The technology vendor is required to register with the central administration, which provides automatic alarm settings for consumable requests, related system failures and faults and desired action for resolution. All service events are recorded. The vendor can have access to automatic fee calculation for services performed under his contract.

Inasmuch as the invention is adaptable to different preferred embodiments and modes of operation, the foregoing should be interpreted as only illustrative of the invention described by the claims below.

We claim:

1. A system for distributing and selling digital entertainment content, said system comprising
an in-person access network with terminals installed at pre-established locations, where potential customers can sample, select, purchase and obtain on the spot entertainment products in physical media or by download, and/or an internet access site with a similar functionality, and
a system of redeemable credits for non-competing companies marketing consumer product goods and services, which credits, once distributed to these companies' customers with their products or otherwise, allow said customers to pay at least part of the price of said content at said access locations or sites, by applying said credits towards the price of said content.

2. A method of distributing and selling digital entertainment content, said method comprising the steps of
providing a remotely and/or locally accessible source of entertainment content,
providing a plurality of in-person content access locations connected to said source and having means for attracting customer attention and desire to interact, means for searching said source, means for previewing content, and means for selling and delivering selected content to customers in physical carriers,
providing a web site having means for offering a similar presentation and functionality as said locations, dependent on customers' access point set-up,
providing exclusive per-product category sponsors, who deal in non-competing products, means for purchasing credit issuing rights, and inducing said sponsors to execute such rights by regularly and or periodically distributing free credits to their customers, which credits, are applicable to the purchase price of said selected content, and
providing entertainment content broadcasters' promotional efforts, content broadcast information and content related news.

3. The invention of claim 2, further comprising distributing said credits by additional means other than through said non-competing sponsors.

4. The invention of claim 2, wherein said credits are distributed upon sale of sponsors' products.

5. The invention of claim 2, wherein said credits are distributed by the sponsors other than in association with their product sales.

6. The invention of claim 2, further comprising advertising the availability of said content and the availability of credits which can be applied against purchase of selected content.

7. The invention of claim 6, further comprising inducing entertainment content customers to effectively utilize such credits in their purchases of entertainment products

8. The invention of claim 7, further comprising causing customers that use credits to pay for part or all of the price of said entertainment content to perceive that they can buy said content consistently at a reduced price or free in some proportion, depending on the channel's policies, the credits the customer has accumulated and the products he purchases.

9. The invention of claim 6, wherein said advertising is by direct mail, fax or email.

10. The invention of claim 6, wherein said advertising is through mass media, public signs, shows, events and other promotional activity.

11. The invention of claim 6, wherein said advertising is done by said sponsors.

12. The invention of claim 2, further comprising providing statistical information and exchanging operational information to said sponsors

13. The invention of claim 2, further comprising a mechanism to sell credits to customers through an agent network

14. The invention of claim 2, further comprising a mechanism to sell credits to customers through other means different than through an agent network

15. The invention of claim 2, further comprising purchasing content from content owners

16. The invention of claim 2, further comprising providing content owners a means to upload content and for making such content available to consumers through an embodiment of the invention.

17. The invention of claim 2, further comprising providing statistical information and exchanging operational information to said content owners.

18. The invention of claim 2, further comprising identifying other content related to said selected content.

19. The invention of claim 2, further comprising providing alternative electronic formats for said selected content.

20. The invention of claim 2, further comprising providing alternative carrier options for said selected content.

21. The invention of claim 2, further comprising providing immediate preview of selected content.

22. The invention of claim 2, wherein the searching means is adapted to permit search on multiple variables.

23. The invention of claim 2, wherein said variables are selected from the group consisting of title, author, performer, period, musical category, lyrics segment, ranks, air play information from radio, open TV, cable TV or other broadcast company, events, and shows.
